(19) United States
(12) Patent Application Publication
(10) Pub. No.: US 2024/0132356 A1
(43) Pub. Date: Apr. 25, 2024

(54) NANOFORMULATED COMPOSITES AND APPLICATIONS THEREOF

(71) Applicant: Olanrewaju Tanimola, Sugar land, TX (US)

(72) Inventor: Olanrewaju Tanimola, Sugar land, TX (US)

(21) Appl. No.: 18/049,289

(22) Filed: Oct. 23, 2022

(51) Int. Cl. C01B 32/158

(52) U.S. Cl. CPC C01B 32/158; C01P 2004/13

(57) ABSTRACT

The present invention discloses a nanoformulated composition comprising a network of one or more nanostructures having a unit formula: wherein the unit formula is (CxHyFM)n, where x is greater than or equal to 6, y is greater than or equal to 3, M is one or more functional groups, F is one or more metals or one or more metal ions.

The present invention discloses a nanoformulated composition comprising a network of one or more nanostructures having a unit formula: the unit formula is (CxHyF)n, where x is greater than or equal to 6, y is greater than or equal to 3, F is one or more metals or one or more metal ions.

### CROSS-REFERENCE TO RELATED APPLICATIONS

This application claims the benefit of the filing date of and priority to: U.S. Provisional Application Ser. No. 62/035,140 entitled “Methods for Synthesis of Graphene Derivatives and Functional Materials from Asphaltenes”, filed Aug. 10, 2015, Confirmation No. 9603; the entire contents of the said provisional application is hereby incorporated by reference.

### STATEMENT REGARDING FEDERALLY SPONSORED RESEARCH OR DEVELOPMENT

Not Applicable.

### BACKGROUND OF THE INVENTION

Nanocarbon heterostructures and non-nanocarbon heterostructures have shown significant improvement in performance compared to conventional materials across numerous technologies. These materials are capable of remarkable enhancements in properties such as, thermal, electrical conductivity, strength and light weighting, catalytic and electrochemical performance etc.

The ability to effectively immobilize molecules of interest in significant volume (biomolecules, metals, metal ions etc.), renders nanostructures as useful compositions in the conferment and retention of much needed properties for a robust engineering application.

In nanocarbon-metal composites or high performance nanocarbon-metal composites known as covetics are higher performance alternatives to alloys, metals, rare earth metals, and graphite. They offer superior properties to conventional oxide or carbide fillers. Due to their ability to promote an improvement in mechanical properties while retaining the thermal and electrical attributes of metals. Thus, enhancing their suitability in a wide-range application prospects in the fields of aerospace, electrochemical, marine, military, and other fields including electronics and automotive industries. Further progress in nanocarbon-metal composites is faced with some challenges including enabling stability of the network structure of graphene; improving the degree of uniform dispersion of graphene in the metal matrix; and strengthening the interface adhesion and wettability between graphene and the metal matrix

Similarly, the exceptional structural morphologies of nanostructures are gaining significant tractions in translational medicines. Extremely thin materials with high surface area offer greater chances of access and exposure towards cells which in turn increases the possibility for cellular interactions and augmenting chances of potential toxicity. Numerous studies have reported their potentials in drug delivery systems, highly efficient photothermal modalities, and multimodal therapeutics with noninvasive diagnostic capabilities, biosensing, and tissue engineering. Precise interaction of nanocarbons with target cancer stem cells and inhibit tumor formation without significant off-target toxicity enhances their selectivity in clinical use. Major limitations to the advancement of nanocarbon based biomedicine include inability to specifically immobilize targets for suitable period of time, lack of structural precision, and presence of impurities in the structure of nanocarbons.

There is a need to address the limitations of nanocarbon composites including severe agglomeration of graphene, weak interfacial bonding and poor structural integrity.

Improving interactions between graphene and the metal matrix. This is also one of the current research hot topics. For example, it is very important to search for new intermediate materials to optimize the bond between the matrix and graphene.

There is a need to develop a nanoformulated framework for composites. It is anticipated that the presence of structural formula could lead to an improved interaction with metal matrix or biomolecules and effectively confer strong interfacial bonds, thus higher performance in terms of mechanical, electrical, optical, biological, and chemical properties.

There is a need to develop a process that enables accurate prediction and manipulation of interactions between nanocarbons and their hosts.

### DETAILED DESCRIPTION OF THE INVENTION

It is an object of the present invention to synthesize a nano-composition material from an asphaltene composition.

It is an object of the present invention to disclose a nanocomposite material having a chemical formula.

It is an object of the present invention to provide a method for synthesizing nanocompositions.

It is an object of the present invention to provide a method for immobilizing a metal or a biomolecule on the structure of a nanocomposition comprising one or more nanocarbon and at least one metal.

It is an object of the present invention to provide a method for synthesizing a nanocomposition comprising one or more nanocarbon and at least one metal

It is an object of the present invention to provide a method for synthesizing a nanoformulated composition comprising a network of one or more carbon nanostructures and a composition comprising at least one metal.

It is an object of the present invention to disclose a nanoformulated composition comprising a network of one or more nanostructures having a unit formula: wherein the unit formula is (CxHyFM)n, where x is greater than or equal to 6, y is greater than or equal to 3, M is one or more functional groups, F is one or more metals or one or more metal ions.

It is an object of the present invention to disclose a nanoformulated composition comprising a network of one or more nanostructures having a unit formula: the unit formula is (CxHyF)n, where x is greater than or equal to 6, y is greater than or equal to 3, F is one or more metals or one or more metal ions.

An object of the present invention relates to the application of the disclosed nanocomposition.

An object of the present invention relates to an electrochemical system coupling a first collector, a binder, a conductive additive, and a first electrode comprising a nanoformulated composition; and a second electrode comprising a nanoformulated composition, a separator and an electrolyte.

An object of the present invention relates to an electrochemical system coupling a first electrode comprising a nanoformulated composition, and a second electrode comprising a nanoformulated composition, a separator and an electrolyte.

An object of the present invention relates to an energy storage device comprising:
(a) a first electrode comprising: (i). a first collector comprising a metal, (ii) first electrode comprising a nanoformulated composition,
(b) a second electrode comprising: (i). a nanoformulated composition, (ii). a separator (iii) an electrolyte

An object of the present invention relates to a sensor device comprising a nanoformulated composition.

An object of the present invention relates to a structure material comprising a nanoformulated composition.

An object of the present invention relates to a catalyst material comprising a nanoformulated composition.

An object of the present invention relates to an adsorbent material comprising a nanoformulated composition.

Present invention wherein the nanoformulated composition is a nanocarbon composition comprising a network of one or more carbon nanostructures having a lattice structure selected from a hexagonal system, an orthorhombic system, a monoclinic system, or a triclinic system.

An example of the nanocarbon composition is a composition comprising a network of one or more carbon nanostructures having a lattice structure formed by (ASU)n, where ASU is asymmetric unit and n>=1, where ASU is (CxHy) or (CxHyF) wherein x=6 or 7, 3≤y≤9 and F is one or more functional groups selected from the group consisting of one or more nitrogen groups, one or more sulfur groups, one or more hydroxyl groups, one or more OR groups, one or more NHOR groups, one or more halogen groups, one or more halide groups, one or more NR₂ groups, one or more SO₃H groups, one or more sulfide groups, one or more azo groups, one or more sulfonate groups, one or more CN groups, one or more CH3 groups, one or more N₂O₄ groups, one or more O₃SH₃O groups, one or more SO₂ groups, one or more NO2 groups, one or more NR3 groups, one or more amide groups, one or more carbonyl groups, one or more oxygen groups, one or more ketone groups, one or more ester groups, one or more carboxyl groups, one or more alkyl groups, one or more acyl groups, one or more carboxylate groups, and combinations thereof.

Present invention wherein the nanoformulated composition is a non-carbon nanocomposition comprising a network of one or more non-carbon nanostructures having a lattice structure selected from a cubic system, a rhombohedral system, an orthorhombic system, monoclinic system, and triclinic system

An example of the non-carbon nanocomposition is a composition comprising a network of one or more carbon nanostructures having a lattice structured formed by (ASU)n, where ASU is asymmetric unit and n>=1, where ASU is (HwTxLy) or (HwTxLyMz) H is hydrogen, where T is an alkaline metal or an alkaline earth metal, L is a chalcogen, O is oxygen, M is hydrogen, w>=0, x>=1, y>=1, z>=0. An example of the non-carbon nanocomposition is a composition comprising a network of one or more 2D nanostructures having lattice formed by an asymmetric unit (ASU)n, where ASU is NaSO₅H₃ or NaSO₄H Na₄S₂O₈. An example of the non-carbon nanocomposition comprising a network of one or more 2D nanostructures having a lattice formed by an asymmetric unit (ASU)n, where ASU is or Na₂S or Na₂S₄ or NaSH

Present invention wherein the nanoformulated composition is a nanocarbon-metal composite comprising a network of one or more nanostructures having a unit formula: where the unit formula is (CxHyFM)n, where x is greater than or equal to 6, y is greater than or equal to 3, M is one or more functional groups, F is one or more metals or one or more metal ions.

Present invention wherein the nanoformulated composition is a nanocarbon-metal composite comprising a network of one or more nanostructures having a unit formula: where the unit formula is (CxHyF)n, where x is greater than or equal to 6, y is greater than or equal to 3, F is one or more metals or one or more metal ions.

The one or more nanostructures of present is selected from the group consisting of one or more 0D nanostructures, one or more 1D nanostructures, and one or more 2D nanostructures.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects feature and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

A. Method of Making Nanoformulated Compositions

A method of making nanoformulated composition comprising: (a) providing a non-carbon nanocomposition, wherein the non-carbon nanocomposition comprises a network of one or more non-carbon nanostructures having a lattice system selected from a cubic system, a rhombohedral system, an orthorhombic system, a monoclinic system, or a triclinic system (b) contacting the non-carbon nanocomposition with a selection from a biomolecule, a metallic composition, a non-metallic composition, or a combination thereof.

A method of making nanoformulated composition comprising: (a) providing a nanocarbon composition, wherein the nanocarbon composition comprises a network of one or more carbon nanostructures having a lattice system selected from a hexagonal, an orthorhombic system, a monoclinic system, or a triclinic system (b) contacting the nanocarbon composition with a selection from a biomolecule, a metallic composition, a non-metallic composition, or a combination thereof.

A method of making a nanoformulated composition comprising: (a) providing a nanocarbon composition, wherein the carbon composition comprises a network of one or more nanostructures having a lattice system selected from an orthorhombic system, a monoclinic system, or a triclinic system (b) contacting the nanocarbon composition with (i). a network of one or more non-carbon nanostructures having a lattice system selected from a cubic system, a rhombohedral system, an orthorhombic system, a monoclinic system, or a triclinic system, and (ii) a selection from a biomolecule, a metallic composition, a non-metallic composition, or a combination thereof.

A method of making nanocomposite comprising: (a) providing a starting material and performing one or more process step selected from, (b) contacting the starting material with one or more additives triclinic system (b) contacting the starting material with one or modifying agents (c) contacting the starting material with one or more controlling agents, (d) performing one or more purification steps.

In one embodiment, the starting material comprises any of: layered materials, stacked materials, asphaltenes, two dimensional materials, molybdenum sulfide, boron nitride, carbon slurry, graphitic compounds, a refluxed solution, soot, lignite, peat, layered materials, PAH compounds, resin, graphite, petrified oil, asphalt, bitumen, an oxidized carbon material, modified bitumen, coal, modified coal, modified asphaltenes, anthracite, modified anthracite and combinations thereof.

The refluxed solution comprises a carbon powder or continuous phase. The one or more additives may comprise an oxidant, a solvent, a surfactant or a dispersant. In one embodiment, the selected temperature ranges from about 25° C. to about 120° C.

The oxidant may be selected from any of: mixed acids, hydrogen peroxide, methanol, ammonia, hydrochloric acid, taurine, nitric acids, sulfuric acids, water, alkyl toluene sulfonic acid and any combination thereof.

The solvent may comprises any of: ammonia, methanol, aromatic solvents, water, tetrahydrofuran, diethyl ether, carbon tetrachloride, hydrogen peroxide, sulfate, alkyl phenol, toluene, benzene, xylene and any combination thereof.

The surfactant may comprise alkyl sulfonic acid oxonium salt. In one embodiment, the dispersant comprises p-alkylphenols, p-alkylbenzenesulfonic acid, or alkyl sulfonic acid. The method may further comprise a step of separating the refluxed solution to produce carbon powder and continuous phase. The separation may comprise filtration, centrifugation, dialysis, solvent extraction, recrystallization, adding solvent and any combination thereof. The method may further comprise adding modifying agent to the refluxed solution to form a modified solution. The modifying agent may comprise any of sodium hydroxide, sodium borohydride, methanol, dioxane, hydrochloric acid, sodium tetrahydrofuran, carbon tetrachloride, copper chloride, phosphoric acid, water, methanol, hydrochloric acid, sodium nitrite, sodium sulfide, copper bromide and a combination thereof. The method can further comprise separating modified solution into carbon powder and continuous phase using any of filtration, centrifugation, dialysis, washing, recrystallization, solvent extraction, addition of solvent, and a combination thereof.

The method can further comprise adding controlling agent to the modified solution to form a controlled solution and further comprise separating the controlled solution into carbon powder and continuous phase using centrifugation, dialysis, washing, recrystallization, solvent extraction, addition of solvent. A modifying agent, such as a continuous phase, may be added to continuous phase to form an assembled solution. The method may also include the steps of recrystallization of the continuous phase or assembled solution to form crystals, benzene derivatives and/or sulfonic derivatives. The recrystallization step may comprise centrifugation, filtration, addition of solvent, incubation.

The starting material may include crude asphaltene or treated asphaltenes e.g., thermally treated asphaltenes, milled asphaltene, mechanically treated, thermo-mechanically treated asphaltene as starting material.

The term “additive” include of heteroatom containing surfactants, acids, mixed acids, solvents, organic solvents, antifoulants, coagulants, flocculants, solubilizing agents, antifoaming agent, emulsifying agents, dispersing agents, ionic liquids, salts, oxidizing agents, reducing agents, catalysts, amphiphilic solvents, dispersants, oxidants, acids, polymer copolymer, biological macromolecules, acidic solution, DNA, protein molecules, organic solvents, polar solvents, non-polar solvents, aromatic solvents, water, alcohol, alkane, acidic ionic liquids and combinations thereof.

In certain aspects the intercalating agents or additives may be selected from any of but not limited to nitric acid, sulfuric acid, aromatic solvent, polar solvent, methanol, water, peroxide, formic acid, benzene, toluene, naphthalene, nitrobenzene sulfonic acid, linear alkyl sulfonic, polytetrafluoroethylene, sodium nitro sulfonic acid, sodium dodecyl sulfate, cetyltrimethylammoniumbromide, phospholipid, lignin, sulfuric acids, ammonia, taurine, tetrahydrofuran, sulfur trioxide, carboxylic acid, acetic acid, carboxylic acids, sulfonic acids and derivatives, carbonic acids, nitro-sulfonic acids, oleic acid, methyl cellulose, diethylene glycol, polyoxyethylrne sorbitan monolaurate, hydrogen peroxide, oxalic acid, perchloric acid, iron bromide, iron chloride, phosphoric acid, hydrofluoric acid, chlorosulfonic acid, trifluoromethanesulfonic acid, nickel, iron, vanadium, permanganate, oleum, chloride, chlorite, nitrite, potassium permanganate, methanol, acetone, water, propanol, isopropanol, dimethyl sulfoxide, polyethylene glycol (PEG), polymer copolymer (PEtOz-Pcl), alkyl phenol, water, Dodecyl benzenesulphonic acid, methanol, tetrachloromethane, taurine, methionine, trichloromethane, tetrahydrofuran, N-(3-dimethylaminopropyl), N′ethyl-carbodiimide hydrochloride, N′ hydroxyl succinimide, poly-lysines (PLs), sodium dodecyl benzenesulfonate, platinum, sodium oleate, cysteine, homocysteine, or mixtures thereof.

A modifying agent or modifier refers to a solvent that contributes to the tuning of the surface or interphase of the refluxed asphaltene solution. A modifier is introduced to alter the edges of the asphaltene emulsion. Such action may result in the change in the structural dimension. In certain aspect a modifier performs several operations that include without limitation addition of functional group(s), elimination of the functional group(s), and substitution of functional group(s).

The modifier comprises a selection from the group consisting of metal catalyst, basic solution, a reducing agent, a salt solution, metal oxides, sulfides, hydrides and any combination thereof. In certain aspects, the modifying agent is a selection from sodium chloride, sodium hydroxide, ammonium hydroxide, hydrochloric acid, tetrahydrofuran, amino triazole, dimethylformamide, dimethylsulfoxide, phosphines, phosphites, sulfites, sulfides, hydrosulfites, borohydrides, boranes, hydroxylamine, lithium alhydride, sodium nitrite, hydrochloric acid, copper bromide, copper cyanide, potassium iodide, borohydrides, hydrochloric acid, cyanoborohydrides, aluminum hydrides, hydroquininone, hydrogen dimethylhydrazine, N,N-dimethylhydroxylamine, methylamine, dioxane, amino acids, dimethylamine, trimethylamine taurine, methionine, potassium hydroxide, tin, methanol, alkali sulfide, distilled water, or mixtures thereof.

A controlling agent is added to the solution when there is a need to neutralize the reaction in order to obtain a stable composition. The controlling agent may also modify the pH of the solution. The selection of a controlling agent is dependent on the pH of the solution; the controlling agent is selected from any of hydrochloric acid, sodium bicarbonate, methanol, dimethyl sulfoxide, sodium hydroxide, potassium hydroxide, tetrahydrofuran, dimethylformamide, alkali sulfide, dimethylsulfoxide, phosphines, phosphites, sulfites, sulfides, dioxane, hydrosulfites, borohydrides, boranes, distilled water, sodium bicarbonate or mixtures thereof.

In certain aspects surfactants, sulfonic derivatives, mixed acids, nitric acid, sulfuric acid, sodium hydroxide, and hydrochloric acid can be used in the methods described. However, other reagents with similar characteristics can also be used in place of these particular reagents.

An embodiment of the invention relates to methods comprising an additive reactor or mixer, a modification reactor, control reactor, separation and recrystallization channel. Methods employed in the present invention can be classified into three groups, dispersant method, dispersant/solvent method, and recycle method.

An embodiment of the invention relates to a reactive capture reaction comprising; providing a capturing material, contacting or interacting the capturing material with one or more components of a mixture to form a reactive capture product. The said mixture comprises a selection from air, a gas, a liquid, a flue gas, a smoke, carbon-di-oxide, nitrogen, oxygen, water or a combination thereof. The capturing material is selected from the group consisting of a fiber, a carbon nanomaterial, graphene derivative, non-carbon nanomaterial, or a combination thereof. The capturing material has a crystal structure selected from the group consisting of a cubic structure, an orthorhombic structure, a monoclinic structure, a triclinic structure, a hexagonal structure or a combination thereof.

An embodiment of the invention relates to a method comprising providing a capturing material or a reactive capture product, contacting the additive with a selection from a metal, a carbon material, a cementitious material, a conductor, a supplementary cementitious material, a steel slag, afly ash, a ceramic, a composite, or a combination thereof. The capturing material or a reactive capture product comprises those mentioned in previous paragraph.

Present invention wherein the nanoformulated composition is a nanocarbon-metal composite comprising a network of one or more nanostructures having a unit formula: where the unit formula is (CxHyF)n, where x is greater than or equal to 6, y is greater than or equal to 3, F is a selection from the group comprising one or more functional groups, one or more biomolecules, one or more metals or one or more metal ions.

An object of the invention relates to a method of making a nanofiber comprising: providing a nanocomposition, providing a nanocomposition, performing one or more process steps selected from dissolving, spinning, rinsing, drying, heating, sizing, or a combination thereof, The nanocomposition comprises a network of one or more carbon nanostructures having a lattice structure formed by (ASU)n, where ASU is asymmetric unit and n>=1, where ASU is (CxHy) or (CxHyF) wherein x=6 or 7, 3≤y≤9 and F is one or more functional groups having a lattice system selected from a hexagonal, an orthorhombic system, a monoclinic system, or a triclinic system. The nanocomposition comprises comprising a network of one or more carbon nanostructures having a lattice structure formed by (ASU)n, where ASU is asymmetric unit and n>=1, where ASU is (HwTxLy) or (HwTxLyMz) H is hydrogen, where T is an alkaline metal or an alkaline earth metal, L is a chalcogen, O is oxygen, M is hydrogen, w>=0, x>=1, y>=1, z>=0. An example of the non-carbon nanocomposition is a composition comprising a network of one or more 2D nanostructures having lattice formed by an asymmetric unit (ASU)n, where ASU is NaSO₅H₃ or NaSO₄H Na₄S₂O₈. An example of the non-carbon nanocomposition comprising a network of one or more 2D nanostructures having a lattice formed by an asymmetric unit (ASU)n, where ASU is or Na₂S or Na₂S₄ or NaSH. An object of the invention relates to a method of making a nanocomposite comprising: (a) providing a nanofiber, the nanofiber is produced by processing a nanocomposition, the processing includes performing one or more processing steps selected from dissolving, spinning, rinsing, drying, heating, sizing, or a combination thereof, the nanocomposition comprises a network of one or more carbon nanostructures having a lattice structure formed by (ASU)n, where ASU is asymmetric unit and n>=1, where ASU is (CxHy) or (CxHyF) wherein x<=7, tha, 3≤y≤9 and F is one or more functional groups having a lattice system selected from a hexagonal, an orthorhombic system, a monoclinic system, or a triclinic system, the nanocomposition comprises comprising a network of one or more carbon nanostructures having a lattice structured formed by (ASU)n, where ASU is asymmetric unit and n>=1, where ASU is (HwTxLy) or (HwTxLyMz) H is hydrogen, where T is an alkaline metal or an alkaline earth metal, L is a chalcogen, O is oxygen, M is hydrogen, w>=0, x>=1, y>=1, z>=0. An example of the non-carbon nanocomposition is a composition comprising a network of one or more 2D nanostructures having lattice formed by an asymmetric unit (ASU)n, where ASU is NaSO5H3 or NaSO4H Na4S2O8. An example of the non-carbon nanocomposition comprising a network of one or more 2D nanostructures having a lattice formed by an asymmetric unit (ASU)n, where ASU is or Na2S or Na2S4 or NaSH.
(b) contacting the nanofiber with one or more materials selected from a metal, a ceramic material, a non-metal, a polymer, a nanomaterial, a metamaterial, a composite, zeolite, a gel, silica gel, a cementitious material, a biomolecule, or a combination thereof. with a selection from a biomolecule, a metallic composition, a non-metallic composition, or a combination thereof.

I claim:

1. A method for synthesis of carbon nanotube comprising: A method of making nanoformulated composition comprising: (a) providing a non-carbon nanocomposition, wherein the non-carbon nanocomposition comprises a network of one or more non-carbon nanostructures having a lattice system selected from a cubic system, a rhombohedral system, an orthorhombic system, a monoclinic system, or a triclinic system (b) contacting the non-carbon nanocomposition with a selection from a biomolecule, a metallic composition, a non-metallic composition, or a combination thereof.

2. A method of a method of making a nanocomposite comprising: providing a nanofiber, contacting the nanofiber with one or more materials selected from a metal, a ceramic material, a non-metal, a polymer, a nanomaterial, a metamaterial, a composite, zeolite, a gel, silica gel, a cementitious material, a biomolecule, or a combination thereof. with a selection from a biomolecule, a metallic composition, a non-metallic composition, or a combination thereof. The nanofiber is produced by processing a nanocomposition, the processing includes performing one or more processing steps selected from dissolving, spinning, rinsing, drying, heating, sizing, or a combination thereof, The nanocomposition comprises a network of one or more carbon nanostructures having a lattice structure formed by (ASU)n, where ASU is asymmetric unit and n>=1, where ASU is (CxHy) or (CxHyF) wherein x=6 or 7, 3≤y≤9 and F is one or more functional groups having a lattice system selected from a hexagonal, an orthorhombic system, a monoclinic system, or a triclinic system. The nanocomposition comprises comprising a network of one or more carbon nanostructures having a lattice structured formed by (ASU)n, where ASU is asymmetric unit and n>=1, where ASU is (HwTxLy) or (HwTxLyMz) H is hydrogen, where T is an alkaline metal or an alkaline earth metal, L is a chalcogen, O is oxygen, M is hydrogen, w>=0, x>=1, y>=1, z>=0.
